(19) United States
(12) Patent Application Publication
(10) Pub. No.: US 2022/0211025 A1
(43) Pub. Date: Jul. 7, 2022

(54) SYSTEM AND METHOD FOR PERFORMING SPRAYING OPERATIONS WITH AN AGRICULTURAL SPRAYER

(71) Applicant: CNH Industrial America LLC, New Holland, PA (US)

(72) Inventors: Kevin M. Smith, Narvon, PA (US); Trevor Stanhope, Oak Lawn, IL (US)

(73) Assignee: CNH Industrial America LLC

(21) Appl. No.: 17/142,747

(22) Filed: Jan. 6, 2021

(51) Int. Cl. A01M 7/00; A01M 21/04; G05B 15/02

(52) U.S. Cl. CPC A01M 7/0089; A01M 7/006; G05B 15/02; A01M 7/0042; A01M 21/043

(57) ABSTRACT

A method for performing spraying operations includes controlling a speed system to move an agricultural sprayer across a field at a speed equal to or below a ground speed limit of the agricultural sprayer, receiving data from a field condition sensor indicative of one or more field conditions within the field, and controlling the operation of a plurality of nozzle assemblies provided in association with a boom of the agricultural sprayer to perform a spraying operation based at least in part on the data received from the field condition sensor. The method additionally includes monitoring an operating parameter indicative of a travel speed of each of the plurality of nozzle assemblies, and automatically adjusting an operation of the agricultural sprayer in response to the determination that the travel speed of at least one of the plurality of nozzle assemblies exceeds or is likely to exceed the ground speed limit.

### FIELD OF THE INVENTION

The present disclosure relates generally to agricultural sprayers and, more particularly, to systems and methods for performing spraying operations with an agricultural sprayer, such as spraying operations that allow for selective application of an agricultural substance onto plants.

### BACKGROUND OF THE INVENTION

Agricultural sprayers apply an agricultural substance (e.g., a pesticide, a nutrient, and/or the like) onto crops and/or a ground surface as the sprayer is traveling across a field. To facilitate such travel, sprayers are configured as self-propelled vehicles or implements towed behind an agricultural tractor or other suitable work vehicle. A typical sprayer includes an outwardly extending boom assembly having a plurality of boom sections supporting a plurality of spaced apart nozzle assemblies. Each nozzle assembly has a valve configured to control the spraying of the agricultural substance through a nozzle onto underlying crops and/or weeds. The boom assembly is disposed in a “floating” arrangement during the spraying operation, wherein the boom sections are extended to cover wide swaths of the field. For transport, the boom assembly is folded to reduce the width of the sprayer.

Some sprayers may control the flow of agricultural substance through individual nozzles based on data received from sensors mounted on the boom sections that detect one or more field conditions (e.g., weeds, moisture content, etc.). Such sensors are typically fixed relative to the respective boom sections on which they are supported. The speed at which the sprayer may make passes through the field is typically limited by the sensing and processing speeds for monitoring the field conditions relative to the boom. However, under certain operating conditions, some or all of the nozzle assemblies may move at speeds above this speed limit, even when the sprayer is driven at or below the speed limit. Further, under certain operating conditions, some or all of the boom sections may move relative to the sprayer vehicle, which can affect the accuracy of detecting field conditions and performing spraying operations with the nozzle assemblies associated with such boom sections.

Accordingly, an improved system and method for performing spraying operations with an agricultural sprayer that takes into account the travel speeds and relative movements of the nozzles would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a method for performing spraying operations. The method includes controlling, with one or more computing devices, a speed system of an agricultural sprayer to move the agricultural sprayer across a field at a first ground speed, where the first ground speed is equal to or below a ground speed limit of the agricultural sprayer, the ground speed limit being selected based at least in part on a reaction time for controlling an operation of a plurality of nozzle assemblies of the agricultural sprayer in response to sensor feedback from a field condition sensor provided in association with a boom of the agricultural sprayer. The method further includes receiving, with the one or more computing devices, data from the field condition sensor indicative of one or more field conditions within the field as the agricultural sprayer moves across the field. Further, the method includes controlling, with the one or more computing devices, the operation of the plurality of nozzle assemblies to perform a spraying operation as the agricultural sprayer moves across the field based at least in part on the data received from the field condition sensor. Furthermore, the method includes monitoring, with the one or more computing devices, an operating parameter indicative of a travel speed of each of the plurality of nozzle assemblies. Moreover, the method includes determining, with the one or more computing devices, that the travel speed of at least one nozzle assembly of the plurality of nozzle assemblies exceeds or is likely to exceed the ground speed limit based at least in part on the monitored operating parameter. Additionally, the method includes automatically adjusting, with the one or more computing devices, an operation of the agricultural sprayer in response to the determination that the travel speed of the at least one nozzle assembly exceeds or is likely to exceed the ground speed limit.

In another aspect, the present subject matter is directed to a system for performing spraying operations. The system includes a boom, a plurality of nozzle assemblies supported on the boom, a field condition sensor provided in association with the boom, and a controller communicatively coupled to the sensor. Each of the plurality of nozzle assemblies are configured to selectively dispense an agricultural product as an agricultural sprayer moves across a field. The field condition sensor is configured to generate data indicative of a field condition within the field. The controller includes a processor and a memory, the memory being configured to store instructions that, when executed by the processor, configure the controller to control a speed system of the agricultural sprayer to move the agricultural sprayer across the field at a first ground speed. The first ground speed is equal to or below a ground speed limit for the agricultural sprayer, where the ground speed limit is selected based at least in part on a reaction time for controlling an operation of the plurality of nozzle assemblies in response to sensor feedback from the field condition sensor. The instructions further configure the controller to receive the data from the field condition sensor as the agricultural sprayer moves across the field, and to control the operation of the plurality of nozzle assemblies to perform a spraying operation as the agricultural sprayer moves across the field based at least in part on the data received from the field condition sensor. Additionally, the instructions configure the controller to monitor an operating parameter indicative of a travel speed of each of the plurality of nozzle assemblies, determine that the travel speed of at least one nozzle assembly of the plurality of nozzle assemblies exceeds or is likely to exceed the ground speed limit based at least in part on the monitored operating parameter, and automatically adjust an operation of the agricultural sprayer in response to the determination that the travel speed of the at least one nozzle assembly exceeds or is likely to exceed the ground speed limit.

In a further aspect, the present subject matter is directed to a method for performing spraying operations. The method may include receiving, with the one or more computing devices, data from a field condition sensor indicative of one or more field conditions within a field as an agricultural sprayer moves across the field, with the field condition sensor being provided in association with a boom of the agricultural sprayer. Further, the method may include controlling, with the one or more computing devices, an operation of a plurality of nozzle assemblies of the agricultural sprayer to perform a selective spraying operation as the agricultural sprayer moves across the field based at least in part on the data received from the field condition sensor. Further still, the method may include monitoring, with the one or more computing devices, an operating parameter indicative of fore-to-aft movement of a portion of the boom relative to a chassis of the agricultural sprayer. Moreover, the method may include determining, with the one or more computing devices, that the fore-to-aft movement of the portion of the boom exceeds or is likely to exceed a movement limit based at least in part on the monitored operating parameter. Additionally, the method may include automatically adjusting, with the one or more computing devices, the operation of at least one nozzle assembly of the plurality of nozzle assemblies to transition from the selective spraying operation to a continuous spray operation in response to the determination that the fore-to-aft movement of the portion of the boom exceeds or is likely to exceed the movement limit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural sprayer in accordance with aspects of the present subject matter;

FIG. 2 illustrates a front view of a boom assembly of an agricultural sprayer in accordance with aspects of the present subject matter;

FIG. 3 illustrates a schematic view of an agricultural sprayer performing a spraying operation in a field in accordance with aspects of the present subject matter;

FIG. 4 illustrates a schematic view of an agricultural sprayer performing a spraying operation in a field using one example embodiment of an operational adjustment in accordance with aspects of the present subject matter;

FIG. 5 illustrates an alternate schematic view of an agricultural sprayer performing a spraying operation in a field using another example embodiment of an operational adjustment in accordance with aspects of the present subject matter;

FIGS. 6A-6B illustrate a sequence of schematic views of an agricultural sprayer performing a spraying operation in a field using one example embodiment of a further operational adjustment in accordance with aspects of the present subject matter;

FIG. 7 illustrates a schematic view of one embodiment of a system for performing spraying operations with an agricultural sprayer in accordance with aspects of the present subject matter;

FIG. 8 illustrates a flow diagram of a method for performing spraying operations with an agricultural sprayer in accordance with aspects of the present subject matter; and

FIG. 9 illustrates a flow diagram of another method for performing spraying operations with an agricultural sprayer in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for performing spraying operations with an agricultural sprayer. Specifically, in several embodiments, a speed system of an agricultural sprayer is controlled to move the sprayer at a ground speed equal to or below a ground speed limit, where the ground speed limit is set based at least in part on a reaction time for detecting field conditions, a reaction time for controlling nozzle assemblies of the sprayer in response to the detected field conditions, and various spray control properties (e.g., nozzle height, supply pressure, droplet size, actual application rate, and/or desired application rate). The nozzle assemblies are generally controlled to perform a spraying operation based on the field conditions detected via field condition sensors supported on the sprayer as the sprayer is moved across the field. For instance, the nozzle assemblies may be controlled to spray weeds detected in the field based on the data received from the field condition sensors. In some embodiments, an operating parameter indicative of a travel speed of each of the nozzle assemblies is monitored relative to the ground speed limit. For instance, the sprayer may include speed sensors mounted to left and right boom assemblies of the sprayer, where the data collected from the speed sensors may be used to determine the actual travel speed of each nozzle assembly. Alternatively, or additionally, the ground speed of the sprayer and the intended steering angle of the sprayer can be monitored to calculate the theoretical travel speeds of each nozzle assembly. If the travel speed of at least one of the nozzle assemblies exceeds or is likely to exceed the ground speed limit, the ground speed of the sprayer may be reduced or the nozzle assemblies with travel speeds above the ground speed limit may be controlled to provide a continuous spray application (e.g., as opposed to a selective spay application).

Similarly, in some embodiments, an operating parameter indicative of fore-to-aft pivoting or swinging of the boom assemblies is monitored relative to a fore-to-aft movement limit. For instance, the sprayer may include rotation sensors and/or acceleration sensors mounted to left and right boom sections of the sprayer, where the data from the position and/or acceleration sensors is used to determine the range and/or acceleration of the fore-to-aft pivoting of the associated sections. If the range and/or acceleration of the fore-to-aft pivoting of the associated sections exceeds or is likely to exceed an angular range limit and/or acceleration limit, respectively, the nozzle assemblies associated with such boom section(s) may be controlled to provide a continuous spray application (e.g., as opposed to a selective spay application). As such, the actual travel speed or movements of the nozzle assemblies may be accounted for, leading to and better management of weeds within a field.

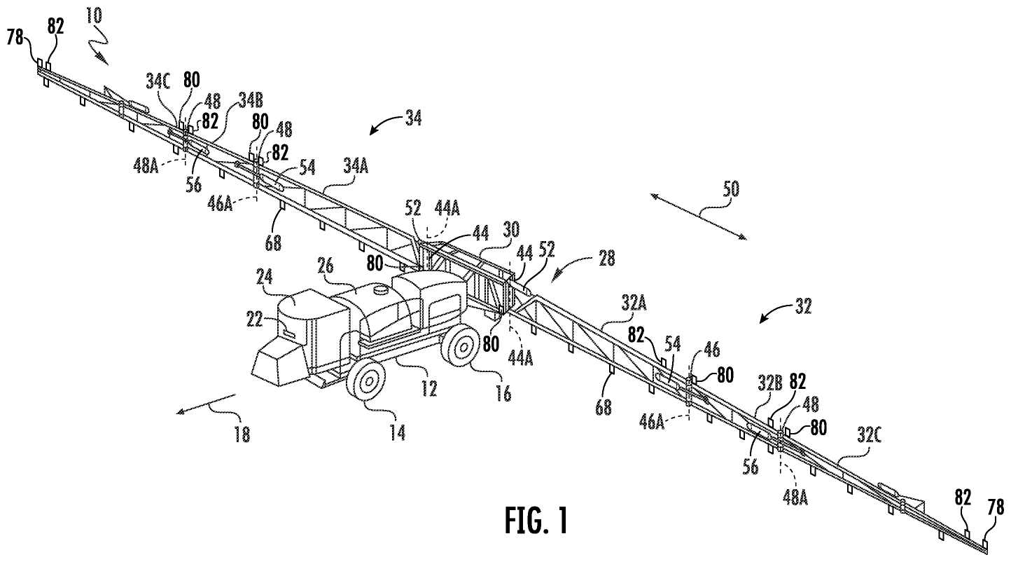

Referring now to the drawings, FIG. 1 illustrates a perspective view of one embodiment of an agricultural sprayer 10 in accordance with aspects of the present subject matter. In the illustrated embodiment, the agricultural sprayer 10 is configured as a self-propelled agricultural sprayer. However, in alternative embodiments, the agricultural sprayer 10 may be configured as any other suitable agricultural vehicle that dispenses an agricultural fluid (e.g., a pesticide or a nutrient) while traveling across a field, such as an agricultural tractor and an associated implement (e.g., a towable sprayer, an inter-seeder, a side-dresser, and/or the like).

As shown in FIG. 1, the agricultural sprayer 10 may include a chassis or frame 12 configured to support or couple to a plurality of components. For example, a pair of steerable front wheels 14 (one is shown) and a pair of driven rear wheels 16 (one is shown) may be coupled to the frame 12. The wheels 14, 16 may be configured to support the agricultural sprayer 10 relative to the ground and move the agricultural sprayer 10 in a direction of travel (e.g., as indicated by arrow 18 in FIG. 1) across a field. In this regard, the agricultural sprayer 10 may include an engine (not shown) and a transmission (not shown) configured to transmit power from the engine to the wheels 14, 16. However, it should be appreciated that, in further embodiments, the front wheels 14 of the agricultural sprayer 10 may be driven in addition to or in lieu of the rear wheels 16. The frame 12 may also support an operator's cab 24 that houses various control or input devices (e.g., levers, pedals, control panels, buttons, and/or the like) for permitting an operator to control the operation of the work vehicle 10. For instance, as shown in FIG. 1, the agricultural sprayer 10 may include a user interface 22 for displaying message windows and/or alerts to the operator and/or for allowing the operator to interface with the vehicle's controller. In one embodiment, the user interface 22 may include buttons, knobs and/or any other suitable input devices that allow the operator to provide user inputs to the controller.

Furthermore, the frame 12 may also support one or more tanks 26 and a frame or boom 28 mounted on the frame 12. Each tank 26 is generally configured to store or hold an agricultural product, such as a pesticide, a nutrient, and/or the like. As will be described in greater detail below, a plurality of nozzle assemblies 68 mounted on the boom assembly 28 may be configured to selectively dispense the agricultural product stored in an associated tank 26 onto the underlying plants and/or soil.

As shown in FIG. 1, in one embodiment, the boom 28 includes a central boom section 30, a left boom section assembly 32, and a right boom section assembly 34. The left boom section assembly 32 includes a left inner boom section 32A pivotably coupled to the central boom section 30, a left middle boom section 32B pivotably coupled to the left inner boom section 32A, and a left outer boom section 32C pivotably coupled to the left middle boom section 32B. Similarly, the right boom section assembly 34 includes a right inner boom section 34A pivotably coupled to the central boom section 30, a right middle boom section 34B pivotably coupled to the right inner boom section 34A, and a right outer boom section 34C pivotably coupled to the right middle boom section 34B. Each of the inner boom sections 32A, 34A is pivotably coupled to the central boom section 30 at pivot joints 44. Similarly, the middle boom sections 32B, 34B are pivotally coupled to the respective inner boom sections 32A, 34A at pivot joints 46 while the outer boom sections 32C, 34C are pivotably coupled to the respective middle boom sections 32B, 34B at pivot joints 48.

As is generally understood, pivot joints 44, 46, 48 may be configured to allow relative pivotal motion between adjacent boom sections of the boom 28. For example, the pivot joints 44, 46, 48 may allow for articulation of the various boom sections between a fully extended or working position (e.g., as shown in FIG. 1), in which the boom sections are unfolded along the lateral direction 50 to allow for the performance of an agricultural spraying operation, and a transport position (not shown), in which the boom sections are folded inwardly to reduce the overall width of the boom 28 along the lateral direction 50. It should be appreciated that, although the boom 28 is shown in FIG. 1 as including a central boom section and three individual boom sections coupled to each side of the central boom sections, the boom 28 may generally have any suitable number of boom sections. For example, in other embodiments, each boom section assembly 32, 34 may include four or more boom sections or less than three boom sections.

Additionally, as shown in FIG. 1, the boom 28 may include inner fold actuators 52 coupled between the inner boom sections 32A, 34A and the central boom section 30 to enable pivoting or folding between the fully-extended working position and the transport position. For example, by retracting/extending the inner fold actuators 52, the inner boom sections 32A, 34A may be pivoted or folded relative to the central boom section 30 about a pivot axis 44A defined by the pivot joints 44. Moreover, the boom 28 may also include middle fold actuators 54 coupled between each inner boom section 32A, 34A and its adjacent middle boom section 32B, 34B and outer fold actuators 56 coupled between each middle boom section 32B, 34B and its adjacent outer boom section 32C, 34C. As such, by retracting/extending the middle and outer fold actuators 54, 56, each middle and outer boom section 32B, 34B, 32C, 34C may be pivoted or folded relative to its respective inwardly adjacent boom section 32A, 34A, 32B, 34B about a respective pivot axis 46A, 48A.

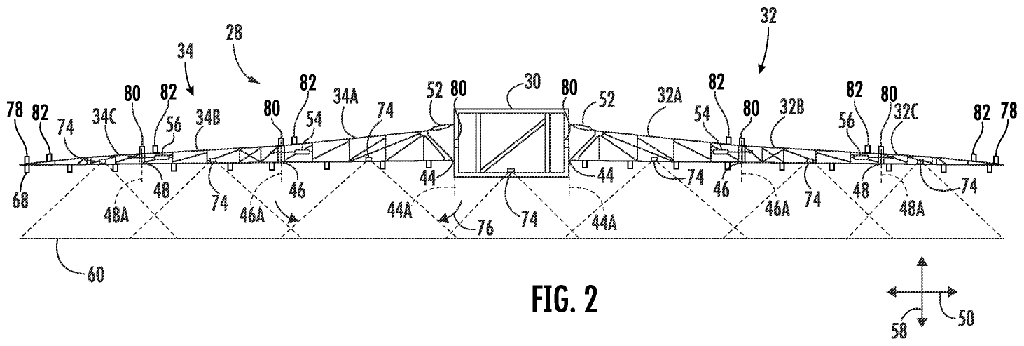

Referring now to FIG. 2, a front view of one embodiment of the boom 28 of the agricultural sprayer 10 is illustrated in accordance with aspects of the present subject matter. As shown, in one embodiment, the boom 28 may further include one or more field condition sensors 74 (hereinafter referred to as “sensors 74”) configured to capture data indicative of field conditions within the field. In several embodiments, the sensor(s) 74 may be installed or otherwise positioned on one or more boom sections of the boom 28. For example, as shown in FIG. 2, a sensor 74 may be positioned on each boom section 30, 32A, 34A, 32B, 34B, 32C, 34C of the boom 28. As such, each sensor 74 may have a field of view or detection zone (e.g., as indicated by dashed lines 76 in FIG. 2) directed toward a location underneath and/or in front of the boom 28 relative to the direction of travel 18. In this regard, each sensor 74 may be able to capture data indicative of a field condition(s) within its detection zone 76. For instance, in one embodiment, the sensors 74 are plant detecting/identifying sensors, where the data captured by the sensors 74 is indicative of the location and/or type of plants within the field. More particularly, in one embodiment, the data captured by the sensors 74 may be used to allow weeds to be distinguished from useful plants within the field (e.g., crops). In such instance, as will be described below, the sensor data may, for instance, be used within a spraying operation to selectively spray or treat the detected/identified weeds (e.g., with a suitable herbicide).

It should be appreciated that the sensors 74 may be positioned at any suitable location(s) on and/or coupled to any other suitable component(s) of the agricultural sprayer 10. Furthermore, it should be appreciated that the agricultural sprayer 10 may include any suitable number of sensors 74 and should not be construed as being limited to the number of sensors 74 shown in FIG. 2. Additionally, it should be appreciated that the sensors 74 may generally correspond to any suitable sensing devices. For example, in one embodiment, each sensor 74 may correspond to any suitable camera(s), such as single-spectrum camera or a multi-spectrum camera configured to capture images, for example, in the visible light range and/or infrared spectral range. Additionally, in a particular embodiment, the camera(s) may correspond to a single lens camera configured to capture two-dimensional images or a stereo camera(s) having two or more lenses with a separate image sensor for each lens to allow the camera(s) to capture stereographic or three-dimensional images. Alternatively, the sensors 74 may correspond to any other suitable image capture device(s) and/or other vision sensor(s) capable of capturing “images” or other image-like data of the field. For example, the sensors 74 may correspond to or include radio detection and ranging (RADAR) sensors and/or light detection and ranging (LIDAR) sensors.

As will be described below in greater detail, a controller of the disclosed system may be configured to control a supply of agricultural product through the nozzle assemblies 68 based at least in part on data generated by the sensors 74 indicative of the field conditions relative to the sprayer 10. More particularly, the nozzle assemblies 68 are spaced apart from each other on the boom 28 along a lateral direction 50. Furthermore, fluid conduits (not shown) may fluidly couple the nozzle assemblies 68 to the tank(s) 26. Each nozzle assembly 68 may include a nozzle valve (not shown) and an associated spray tip or spray nozzle (not shown). In several embodiments, the operation of each nozzle valve may be individually controlled by the controller such that the valve regulates the flow rate and/or other spray characteristic of the agricultural product through the associated spray nozzle. Such individual control of the operation of the nozzle valves may be used to selectively spray agricultural product onto a field. For example, such individual control of the operation of the nozzle valves may be used to spray weeds identified or mapped within a field.

During operation of the sprayer 10, the various boom sections of the boom 28 may travel at a different speed from the chassis 12 and/or move relative to the chassis 12. For instance, during a turn, the boom sections on the outside of the turn may travel faster than the chassis 12 while the boom sections on the inside of the turn may travel slower than the chassis 12. Similarly, the various boom sections may significantly yaw fore-to-aft relative to the chassis 12. As such, it is possible that the travel speed and/or the fore-to-aft movement of one or more of the nozzle assemblies may exceed a respective limit of the agricultural sprayer for accurately controlling the nozzle assemblies 68 based on detected field conditions (such as weeds) to provide a selective spray application, even when the chassis 12 is moving at or below the ground speed limit. The limits discussed herein may generally be determined based on one or more of the turning radius of the agricultural sprayer 10, a boom height of the boom 28, a look-ahead distance of the field condition sensor(s) 74, a processing lag for processing the data received from the field condition sensor(s) 74, a control lag for adjusting the operation of the nozzle assemblies 68, and a maximum spray application rate.

In several embodiments, the sprayer 10 may include one or more ground speed sensors 78 (hereinafter referred to as “speed sensors 78”), one or more rotation sensors 80 and/or one or more acceleration sensors 82. The speed sensors 78 are configured to capture data indicative of a ground travel speed of a respective boom portion. In several embodiments, the speed sensors 78 may be installed or otherwise positioned on two or more boom sections of the boom 28. For example, as shown in FIGS. 1 and 2, a speed sensor 78 may be positioned on the left and right outer boom sections 32C, 34C of the boom 28. As such, the speed sensor 78 supported on the left outer boom section 32C may be able to capture data indicative of a travel speed of the left outer boom section 32C and the speed sensor 78 supported on the right outer boom section 34C may be able to capture data indicative of a travel speed of the right outer boom section 34C. Using the data from the speed sensors 78, in addition to the ground speed of the chassis 12, the travel speeds of each of the nozzle assemblies 68 may be extrapolated based on the known distance of each of the nozzle assemblies 68 from the associated speed sensor(s) 78 and the central boom section 30.

It should be appreciated that the speed sensors 78 may be positioned at any suitable location(s) on and/or coupled to any other suitable component(s) of the agricultural sprayer 10. Furthermore, it should be appreciated that the agricultural sprayer 10 may include any suitable number of speed sensors 78 and should not be construed as being limited to the number of speed sensors 78 shown. Additionally, it should be appreciated that the speed sensors 78 may generally correspond to any suitable sensing devices. For instance, the speed sensors 78 may be configured as GPS-based speed sensors, radar speed sensors, and/or the like.

Similarly, the rotation sensors 80 and/or acceleration sensor(s) 82 are configured to capture data indicative of fore-to-aft movement of the boom assemblies 32, 34 relative to the chassis 12. For instance, when the sprayer 10 traverses a bump or has a change in speed or direction, one or more of the boom sections of the boom assemblies 32, 34 may start to oscillate in the fore-to-aft direction, rotating about the rotational axes 44A, 46A, 48A. As such, the rotation sensors 80 are installed or otherwise positioned to determine the pivoting or swinging the left and right boom assemblies 32, 34 about one or more of the rotational axes 44A, 46A, 48A. Similarly, the acceleration sensors 82 are installed or otherwise positioned to determine the acceleration of a respective boom section in the fore-to-aft direction. Using the data from the rotation sensors 80, it can be determined if the boom sections are rotating outside of an acceptable angular range for performing a selective spraying operation. Similarly, using the data from the acceleration sensors 82, it can be determined if the boom sections are accelerating faster than an acceptable acceleration limit for performing a selective spraying operation. It should be appreciated that the rotation sensors 80 and/or the acceleration sensors 82 may be positioned at any suitable location(s) on and/or coupled to any other suitable component(s) of the agricultural sprayer 10. Furthermore, it should be appreciated that the agricultural sprayer 10 may include any suitable number of rotation sensors 80 and/or acceleration sensors 82 and should not be construed as being limited to the number of sensors 80, 82 shown. Additionally, it should be appreciated that the rotation sensors 80 and the acceleration sensors 82 may generally correspond to any suitable sensing devices.

As will be described below, the operation of the agricultural sprayer 10 may be adjusted based on the travel speed of each of the nozzle assemblies 68, for example, to control the nozzle assemblies 68 or the speed of the sprayer 10. Additionally, or alternatively, the operation of the agricultural sprayer 10 may be adjusted based on the fore-to-aft movement of the boom sections (and associated nozzle assemblies 68), for example, to control the nozzle assemblies 68 and/or the fold actuator(s) of the boom assembly 28.

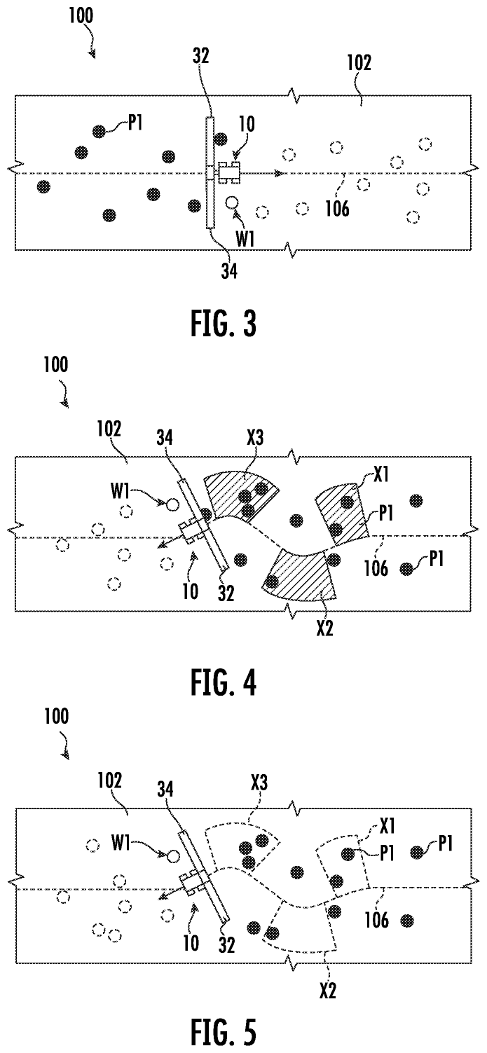

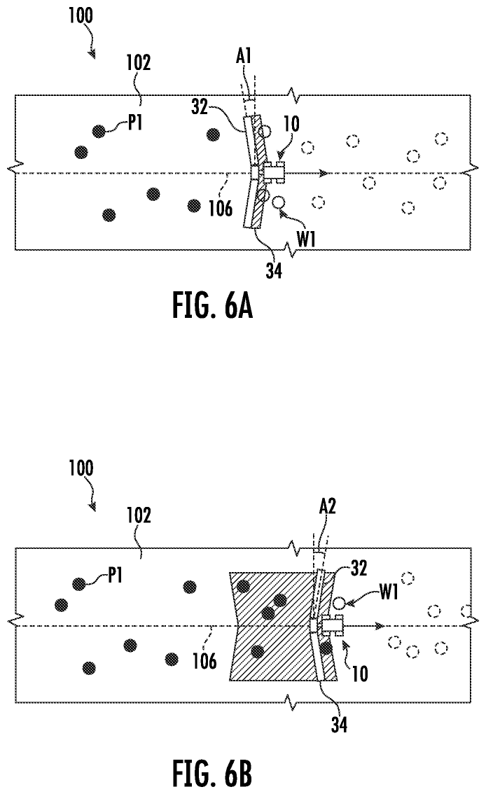

Referring now to FIGS. 3-6B, several example embodiments of sprayer adjustments that may be made according to the present subject matter are illustrated. Particularly, FIG. 3 illustrates a schematic view in which an agricultural sprayer is shown performing a spraying operation in a field. FIG. 4 illustrates a schematic view in which an agricultural sprayer is shown performing a spraying operation in a field in accordance with one example embodiment of an operational adjustment. FIG. 5 illustrates an alternate schematic view in which an agricultural sprayer is performing a spraying operation in a field in accordance with another example embodiment of an operational adjustment. Additionally, FIGS. 6A and 6B illustrate a sequence of schematic views in which an agricultural sprayer is performing a spraying operation in a field in accordance with one example embodiment of a further operational adjustment.

As shown in the various embodiments illustrated in FIGS. 3-6B, a field 100 includes a working area 102. The working area 102 has a plurality of swath or guidance lines 106 (one of which is shown) generally extending in an operating direction of the sprayer 10 across the working area 102. As is generally understood, the guidance lines 106 may correspond to predetermined or pre-generated guidance lines representing anticipated or desired paths or passes across the field 100 for performing an agricultural operation (e.g., spraying operation, and/or the like) with the sprayer 10. It should be appreciated that the guidance lines 106 may be straight, as shown in FIGS. 3, 6A, and 6B, or curved, as shown in FIGS. 4 and 5. Such guidance lines 106 may be stored within the memory of one or more components of the disclosed system. In several embodiments, the agricultural sprayer 10 may be automatically, semi-automatically, or manually controlled to follow the guidance lines 106 during the performance of an agricultural operation.

As indicated above, in one embodiment, the field condition sensors 74 associated with the boom 28 may be used to detect field conditions (e.g., weeds, plants, etc.) across a swath for subsequently controlling the nozzle assemblies 68 supported on the boom 28. For example, as shown in FIG. 3, the agricultural sprayer 10 is shown making a pass across straight guidance line 106 during nominal operating conditions (no fore-to-aft movement) at a ground speed equal to or less than a ground speed limit, where the ground speed limit is set based at least in part on a reaction time for controlling nozzle assemblies 68 of the sprayer 10 in response to detected field conditions, and/or a spray parameters or characteristics (e.g., nozzle height, supply pressure, droplet size, actual application rate, and/or desired application rate). The field condition sensors 74 generate data indicative of the field conditions (e.g., weeds), and the data indicative of the field conditions is analyzed to determine the location of plants (e.g., weeds W1) within the swath. Further, data generated by the speed sensors 78 and/or inputs received from the steering system of the sprayer 10 indicates that the travel speed of the left and right boom assemblies 32, 34 (and thus, of the individual nozzle assemblies 68) is substantially equal to the ground speed of the sprayer 10. Additionally, or alternatively, data generated by the rotation sensors 80 and/or acceleration sensors 82 indicates that the left and right boom assemblies 32, 34 have little to no fore-to-aft movement and/or acceleration relative to the central boom section 30, and thus, the nozzle assemblies 68 have little fore-to-aft movement relative to the chassis 12. Since the travel speed and the fore-to-aft movement of each of the individual nozzle assemblies 68 does not exceed the ground speed limit based on the data from the speed sensors 78, the rotation sensors 80 and/or the acceleration sensors 82, the nozzle assemblies 68 are selectively controlled to spray weeds W1 with an agricultural product P1.

However, when the agricultural sprayer 10 makes a pass across a guidance line 106 that includes curves at a ground speed equal or close to the ground speed limit, a travel speed of one or more of the nozzle assemblies 68 may exceed the ground speed limit. For instance, as shown in FIGS. 4 and 5, the guidance line 106 has curves within a first region X1, a second region X2, and a third region X3. Within each of the first and third regions X1, X3 in FIGS. 4 and 5, the guidance line 106 has a curve to the left. As such, if the sprayer 10 continues to move at a speed at or close to the ground speed limit within the first and third regions X1, X3, the travel speed of at least a portion of the outer boom assembly (i.e., the boom assembly located on the outside of the turn—in this case, the right boom assembly 34) will exceed the ground speed limit. Thus, the travel speed of the nozzle assemblies 68 supported on such portion of the outer boom assembly (e.g., the portion of the right boom assembly 34) will also exceed the ground speed limit while the sprayer 10 moves across the first and third regions X1, X3 (assuming no control action is taken). Similarly, in the second region X2, the guidance line 106 has a curve to the right, which, if the sprayer 10 continues to move at or near the ground speed limit, will cause the travel speed of a portion of the outer boom assembly (e.g., in this case, a portion of the left boom assembly 32) to exceed the ground speed limit. As such, the travel speed of the nozzle assemblies 68 supported on such portion of the outer boom assembly (e.g., the portion of the left boom assembly 32) will also exceed the ground speed limit while the sprayer 10 moves across the second region X2 (again, assuming no control action is taken).

As noted above, when one or more of the nozzles assemblies 68 have travel speeds that exceed the ground speed limit, there is insufficient time to selectively control such nozzle assemblies 68 based on the data received from the field condition sensors. Accordingly, to address this issue, a controller of the disclosed system may adjust the operation of the sprayer 10 in response to the determining that one or more of the nozzle assemblies are traveling at excessive speeds.

In one embodiment, the controller of the disclosed system may be configured to adjust the operation of the nozzle assemblies 68 to switch from a selective spray mode to a continuous spray mode to account for excessive nozzle speeds. For instance, in the embodiment shown in FIG. 4, it will be assumed that the travel speeds of all of the nozzle assemblies 68 on the right boom assembly 34 exceed the ground speed limit while the sprayer 10 travels across the first and third regions X1, X3 and that the travel speeds of all of the nozzle assemblies 68 on the left boom assembly 32 exceed the ground speed limit while the sprayer 10 travels across the second region X2. In such an embodiment, the operation of all of the nozzle assemblies 68 on the outer boom assembly (e.g., the right boom assembly 34 within the first and third regions X1, X3 or the left boom assembly 32 within the second region X2) may be temporarily transitioned to a continuous spray mode in which the nozzle assemblies 68 are continuously activated to ensure that weeds are sufficiently sprayed given the excessive nozzle speeds along such outer boom assembly.

Further, in some embodiments, it should be appreciated that the spray application rate may be monitored relative to a desired spray application rate by a controller of the disclosed system. If one or more spray parameters associated with the spray application rate have reached an associated maximum for the current speed of the sprayer 10, but the spray application rate cannot be further increased to reach the desired spray application rate, a speed system of the sprayer 10 may be controlled to slow the ground speed of the sprayer 10 to allow the spray application rate to reach the desired spray application rate. For example, if the nozzle assemblies 68 are controlled to continuously spray (i.e., at a duty cycle of 100%) at a particular speed, the effective spray application rate or coverage may be lower than a desired spray application rate, but the nozzle assemblies 68 cannot be controlled to further increase the spray application rate. In such instance, the speed system of the sprayer 10 is then controlled to reduce the speed of the sprayer 10 such that the effective spray application rate of the nozzle assemblies 68 is increased to the desired spray application rate.

In one embodiment, the nozzle assemblies 68 on the inside boom assembly (e.g., the left boom assembly 32 within the first and third regions X1, X3 or the right boom assembly 34 within the second region X2) will continue to be operated in the selective spray mode to allow such nozzle assemblies 68 to selectively spray weeds W1 while the sprayer 10 moves across each curved region. However, in alternative embodiments, it should be appreciated that the nozzle assemblies 68 on the inside boom assembly may, instead, be controlled to continuously spray while the sprayer 10 moves within the curved region. Moreover, it should be appreciated that, in some embodiments, the nozzle assemblies 68 associated with the outer boom assembly may be controlled to return to the selective spray mode once their travel speeds fall below the ground speed limit (e.g., after the sprayer exits a region with curvature, such as after the first region X1, after the second region X2, and after the third region X3). Additionally, it should be appreciated that, while all of the nozzle assemblies 68 associated with the outer boom assembly are described as having travel speeds exceeding the ground speed limit, in some embodiments, only a portion of the nozzle assemblies 68 associated with the outer boom assembly will have travel speeds that exceed the ground speed limit. In such instance, only those nozzle assemblies 68 with travel speeds that exceed the ground speed limit need to be controlled to transition from a selective spray mode to a continuous spray mode.

In some embodiments, the controller of the disclosed system may be configured to adjust the ground speed of the sprayer 10 to account for or anticipate excessive travel speeds of the nozzle assemblies 68 (e.g., during travel through regions X1, X2, X3). For example, in the embodiment shown in FIG. 5, a speed system of the sprayer 10 may be controlled to reduce the ground speed of the sprayer 10 from an original speed (e.g., the ground speed limit) to a lower speed within the regions X1, X2, X3, such that the travel speed of each of the nozzle assemblies 68 on the outer boom assembly (e.g., the left boom assembly 32 within the first and third regions X1, X3 or the right boom assembly 34 within the second region X2) is maintained at or below the ground speed limit based at least in part on the measured travel speeds of the nozzle assemblies 68 and/or on the theoretical speeds of the nozzle assemblies 68 determined based on a steering angle and ground speed of the sprayer 10 while being guided along the curves of the guidance line 106. As such, the nozzle assemblies 68 on the outer boom assembly may continue to be operated in the selective spray mode while traveling at the lower speeds within the regions X1, X2, X3. In one embodiment, the lower ground speed for the sprayer is selected based on the curvatures within each region X1, X2, X3 such that the fastest ground speed may be used within each region without the travel speed of any of the nozzle assemblies 68 exceeding the ground speed limit due to the turning of the sprayer 10. It should be appreciated that, in some embodiments, the lower ground speed may be predetermined and stored for each of a plurality of curvature radiuses (e.g., the curvatures within the regions X1, X2, X3). However, in other embodiments, a single reduced ground speed may be used for curvatures having any radius. Additionally, it should be appreciated that the ground speed of the sprayer 10 may be increased back to the original ground speed (e.g., the ground speed limit) after exiting a region with curvature, such as after the first region X1, after the second region X2, and after the third region X3.

When the agricultural sprayer 10 makes a pass across a guidance line 106 while the boom assemblies 32, 34 swing relative to the central boom section 30 (and chassis 12) in the fore-to-aft direction, one or more of the nozzle assemblies 68 may exceed a movement limit(s) for performing a selective spraying operation. For instance, as shown in FIGS. 6A and 6B, the sprayer 10 is moving across the field at the ground speed limit, and the boom assemblies 32, 34 are detected by the rotational sensors 80 to have pivoted relative to their normal positions (and thus, relative to the central boom section 30 and chassis 12) to a rearward-most position (e.g., as indicated by a first angle A1) and to a forward-most position (e.g., as indicated by a second angle A2). As the boom assemblies 32, 34 move into such aft position A1, the acceleration sensors 82 will detect acceleration in the rearward direction and the forward travel speed of each of the nozzle assemblies 68 detected by the speed sensors 78 will be less than the speed of the sprayer 10 (e.g., the ground speed limit). When boom assemblies 32, 34 reach the aft position A1, the acceleration of the boom assemblies 32, 34 instantaneously drops to zero such that the travel speed of each of the nozzle assemblies 68 is momentarily equal to the speed of the sprayer 10 (e.g., the ground speed limit). However, as the boom assemblies 32, 34 swing forward towards the forwardmost position A2, the acceleration sensors 82 will detect acceleration in the forward direction and the forward travel speed of each of the nozzle assemblies 68 detected by the speed sensors 78 will be greater than the speed of the sprayer 10 (e.g., the ground speed limit). When the boom assemblies 32, 34 reach such forward position A2, the acceleration of the boom assemblies 32, 34 instantaneously drops to zero such that the travel speed of each of the nozzle assemblies 68 is momentarily equal to the speed of the sprayer 10 (e.g., the ground speed limit).

In some embodiments, the movement limit corresponds to an angular range for performing a selective spraying operation with the sprayer 10, where the angular range is defined between a maximum rearward angular position limit and a maximum forward angular position limit. Similarly, in some embodiments, the movement limit corresponds to an acceleration limit for performing a selective spraying operation with the sprayer 10. In the example described, the rearward-most position A1 exceeds the maximum rearward angular position limit, the forward-most position A2 exceeds the maximum forward angular position limit, and/or the accelerations detected as the boom assemblies 32, 34 move into such positions A1, A2 exceed the acceleration limit. As such, during such fore-to-aft movement of the boom assemblies 32, 34, there is insufficient time to selectively control the nozzles assemblies 68 as they quickly accelerate/decelerate, change directions, and often exceed the ground speed limit.

As such, a controller of the disclosed system may be used to adjust the operation of the sprayer 10 during such fore-to-aft movement. For instance, in one embodiment, the controller of the disclosed system may be configured to adjust the operation of the nozzle assemblies 68 when it is detected that the boom assemblies 32, 34 are currently swinging back-and-forth in the fore-to-aft direction. For example, as shown in FIGS. 6A and 6B, the nozzle assemblies 68 may be controlled to operate in a continuous spray mode while the boom assemblies 32, 34 are swinging back-and-forth in the fore-to-aft direction between the first and second angular positions A1, A2 exceeding the angular position range limits and/or while accelerating above than the acceleration limit. Further, in some embodiments, the fold actuator(s) 52 of the boom 28 may be controlled to slow down or stop the oscillation of the boom assemblies 32, 34 in the fore-to-aft direction. It should be appreciated that, in some embodiments, the nozzle assemblies 68 may be controlled to return to the selective spray mode after such fore-to-aft boom movement is stopped or reduced to below a predetermined threshold.

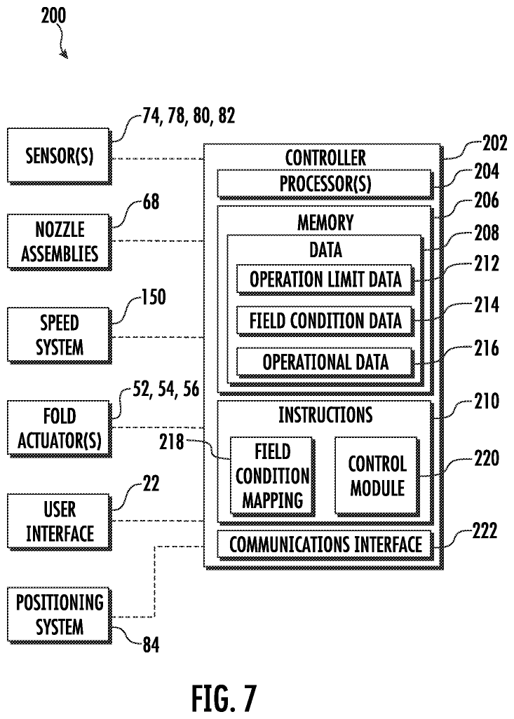

Referring now to FIG. 7, a schematic view of a system 200 for performing spraying operations with an agricultural sprayer is illustrated in accordance with aspects of the present subject matter. In general, the system 200 will be described herein with reference to the sprayer 10 described above with reference to FIGS. 1-2, as well as the operational adjustments described above with reference to FIGS. 3-6B. However, it should be appreciated by those of ordinary skill in the art that the disclosed system 200 may generally be utilized with sprayers having any suitable sprayer configuration, and/or with any other suitable operational adjustments. Additionally, it should be appreciated that, for purposes of illustration, communicative links or electrical couplings of the system 200 shown in FIG. 7 are indicated by dashed lines.

In several embodiments, the system 200 may include a controller 202 and various other components configured to be communicatively coupled to and/or controlled by the controller 202. For instance, the controller 202 may be communicatively coupled to one or more field condition sensors 74 configured to generate data indicative of field conditions of a swath within a field, one or more speed sensors 78 configured to generate data indicative of a travel speed of a respective boom portion, one or more rotation sensors 80 configured to generate data indicative of pivoting of respective boom sections relative to the chassis 12, and/or one or more acceleration sensors 82 configured to generate data indicative of a fore-to-aft acceleration of a respective boom section relative to the direction of travel 18. Further, the controller 202 may be communicatively coupled to one or more nozzle assemblies 68 configured to be controlled based at least in part on the determined field conditions and the travel speed of the nozzle assemblies 68, a speed system 150 configured to control the speed of the agricultural sprayer 10 (e.g., by control of a throttle, a clutch, brakes, a transmission, one or more other systems or sub-systems, or a combination thereof), inner fold actuators 52, 54, 56 configured to rotate the boom sections about their respective pivot axes, and a user interface (e.g., user interface 22). It should be appreciated that the user interface 22 described herein may include, without limitation, any combination of input and/or output devices that allow an operator to provide operator inputs to the controller 202 and/or that allow the controller 202 to provide feedback to the operator, such as a keyboard, keypad, pointing device, buttons, knobs, touch sensitive screen, mobile device, audio input device, audio output device, and/or the like. The controller 202 may additionally be communicatively coupled to one or more positioning devices 84. In some embodiments, the positioning device 84 may be configured as a satellite navigation positioning device (e.g. a GPS system, a Galileo positioning system, a Global Navigation satellite system (GLONASS), a BeiDou Satellite Navigation and Positioning system, a dead reckoning device, and/or the like) to determine the location of the sprayer 10 and/or the boom 28.

In general, the controller 202 may correspond to any suitable processor-based device(s), such as a computing device or any combination of computing devices. Thus, as shown in FIG. 7, the controller 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 210 that can be executed by the processor(s) 204.

It should be appreciated that the controller 202 may correspond to an existing controller for the sprayer 10 or may correspond to a separate processing device. For instance, in one embodiment, the controller 202 may form all or part of a separate plug-in module that may be installed in operative association with the sprayer 10 to allow for the disclosed system and method to be implemented without requiring additional software to be uploaded onto existing control devices of the sprayer 10.

In several embodiments, the data 208 may be stored in one or more databases. For example, the memory 206 may include an operation limit database 212 for storing operation limits for the sprayer. Particularly, in several embodiments the operation limits may include a ground speed limit for the sprayer 10, particularly for controlling the nozzle assemblies 68 of the sprayer. As indicated above, the ground speed limit is based at least in part on a reaction time for identifying field conditions based on the data received from the field condition sensors 74 and subsequently controlling the nozzle assemblies 68 of the sprayer in response to the detected field conditions. It should be appreciated that the operation limit database may also include any other suitable operating limit(s) that affects the time for delivering agricultural product, such as a boom height limit.

Further, the memory 206 may include a field condition database 214 for storing field condition data received from the sensors(s) 74 and/or the positioning device(s) 84. For instance, the plant-identifying sensor(s) 74 may be configured to continuously, periodically, or otherwise capture data associated with a portion of the field, such as during a pass within the field as described above with reference to FIGS. 3-6B. In such an embodiment, the data transmitted to the controller 202 from the plant-identifying sensor(s) 74 may be stored within the field condition database 214 for subsequent processing and/or analysis. It should be appreciated that, as used herein, the term “field condition data” may include any suitable type of data received from the sensor(s) 74 that allows for the field condition (e.g., plants, weeds, etc.) of a field to be analyzed, including photographs or other images, RADAR data, LIDAR data, and/or other image-related data (e.g., scan data and/or the like). Further, data from the positioning device(s) 84 may be received simultaneously with the data from the sensor(s) 74 and stored in association with such data from the sensor(s) 74 for later use in geolocating plants within the field as will be described below.

Additionally, the memory 206 may include an operating parameter database 216 for storing operating parameter data received from the speed sensors 78, the rotation sensors 80, and/or the positioning device(s) 84. For instance, the sensors 78, 80 may be configured to continuously, periodically, or otherwise capture data associated with an operating parameter of the sprayer 10, such as a travel speed of the outer boom assemblies 32C, 34C and/or the pivoting motion of the boom assemblies 32, 34 relative to the central boom section 30 during a pass within the field as described above with reference to FIGS. 3-6B. In such an embodiment, the data transmitted to the controller 202 from the sensors 78, 80 may be stored within the operating parameter database 216 for subsequent processing and/or analysis. It should be appreciated that, as used herein, the term “operating parameter data” may include any suitable type of data received from the sensors 78, 80 that allows for the travel speed of each of the nozzle assemblies 68 to be determined. Further, data from the positioning device(s) 84 may be received simultaneously with the data from the sensors 78, 80 and stored in association with such data for later use in more accurately geolocating plants within the field relative to the sprayer 10.

In some embodiments, the instructions 210 stored within the memory 206 of the controller 202 may be executed by the processor(s) 204 to implement a field condition mapping module 218. In general, the field condition mapping module 218 map may be configured to assess the field condition data 214 deriving from the sensor(s) 74 and associated position data from the position device(s) 84, and geo-locate detected field conditions within the field. The location of the detected field conditions within the field may be adjusted depending on the actual position of the boom assemblies based on the data from the sensor(s) 80. In one embodiment, the field condition(s) may include the presence of weeds or other undesirable or non-useful plants. As such, in one embodiment, as the sprayer 10 travels across the field, the controller 202 may be configured to receive sensor data (e.g., image data) associated with plants within the field from the sensors 74 (e.g., plant-identifying sensor(s)). For instance, as indicated above, in one embodiment, data may be captured from sensor(s) 74 indicative of field conditions (e.g., weeds W1 in FIGS. 3-6B) within the swath.

Thereafter, the controller 202 may configured to analyze/process the received image data to detect/identify the type and location of plants. In this regard, the controller 202 may include any suitable image processing algorithms stored within its memory 206 or may otherwise use any suitable image processing techniques to determine, for example, the presence and locations of weeds within the field based on the received sensor data. For instance, in some embodiments, the controller 202 may be able to directly distinguish between weeds and emerging/standing crops. However, in some embodiments, the controller 202 may be configured to indirectly distinguish between weeds and emerging/standing crops, such as by identifying crop rows of emerging/standing crops and then inferring that plants positioned between adjacent crop rows are weeds. Alternatively, or additionally, in some embodiments, all living plants (e.g., weeds and crops) may be identified as requiring treatment. Such field condition map may subsequently be used as, or used to generate, a prescription map for controlling the nozzle assemblies 68.

The instructions 210 stored within the memory 206 of the controller 202 may further be executed by the processor(s) 204 to implement a control module 220. The control module 220 may generally be configured to perform a control action based on the monitored field condition. In several embodiments, the control action includes controlling the operation of one or more of the nozzle assemblies 68 to spray a product (e.g., product P1) on plants identified during a previous pass across the field. As indicated above, the nozzle assemblies 68 may be controlled based on the mapped field conditions (e.g., weeds) and travel speed of each of the nozzle assemblies 68. For instance, as described above with reference to FIGS. 4, 6A, and 6B, each of the nozzle assemblies 68 determined to have a travel speed above the predetermined ground speed limit, a fore-to-aft acceleration above an acceleration limit, and/or be supported on a boom section having an angular position beyond an angular range may be controlled to be operated in a continuous spray mode. In some embodiments, the control action includes controlling the speed system 150 of the sprayer 10. For instance, as described above with reference to FIG. 5, if one or more nozzle assemblies 68 are determined to have a travel speed above the predetermined ground speed limit, the speed system 150 may be controlled to reduce the ground speed of the sprayer 10 such that the travel speed of each of the nozzle assemblies 68 is at or below the ground speed limit. Further, in some embodiments, when it is determined that boom sections are pivoting back-and-forth relative to the central boom section 30 in the fore-to-aft direction at an acceleration above an acceleration threshold and/or at angles outside of an angular range as the sprayer 10 makes a pass across a field, the control action may include controlling the fold actuators 52, 54, 56 to slow or stop such rotation. Additionally, in some embodiments, the control action may include controlling the operation of the user interface 22 to provide a notification to the operator, such as by displaying the field map generated by the field condition mapping module 218, the progress of the spraying operation within the field, and/or the like.

Referring still to FIG. 7, the controller 202 may also include a communications interface 222 to provide a means for the controller 202 to communicate with any of the various other system components described herein. For instance, one or more communicative links or interfaces (e.g., one or more data buses) may be provided between the communications interface 222 and the sensor(s) 74, 78, 80, 82 to allow data transmitted from the sensor(s) 74 to be received by the controller 202. Similarly, one or more communicative links or interfaces (e.g., one or more data buses) may be provided between the communications interface 218 and the nozzle assemblies 68 (e.g., electronic valves associated with the nozzle assemblies 68) to control the spraying operation of the nozzle assemblies 68. Additionally, in some embodiments, one or more communicative links or interfaces (e.g., one or more data buses) may be provided between the communications interface 218 and the user interface 80 to present the field map generated by the field condition mapping module 214 to the operator.

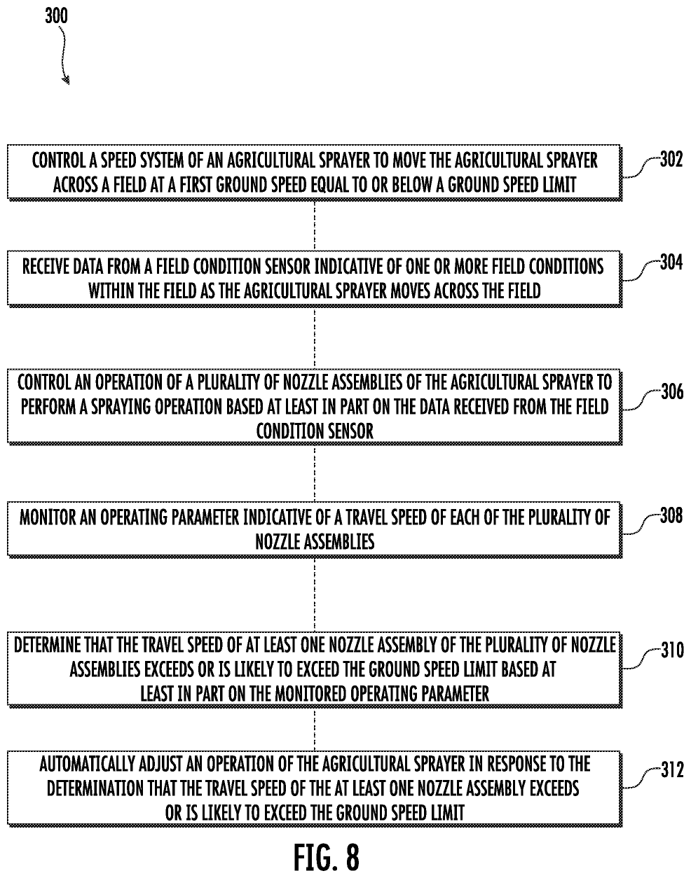

Referring now to FIG. 8, a flow diagram of one embodiment of a method 300 for performing spraying operations with an agricultural sprayer is illustrated in accordance with aspects of the present subject matter. In general, the method 300 will be described herein with reference to the sprayer 10 described above with reference to FIGS. 1-2, the example operational adjustments shown in FIGS. 3-5, and the system 200 described above with reference to FIG. 7. However, it should be appreciated that the disclosed method 300 may be implemented with systems having any other suitable system configuration and/or in connection with any other suitable work routes. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (302), the method 300 may include controlling a speed system of an agricultural sprayer to move the agricultural sprayer across a field at a first ground speed equal to or below a ground speed limit. For example, as described above, the controller 202 may be configured to control a speed system 150 of an agricultural sprayer 10 to move the agricultural sprayer 10 across a field 100 at a first ground speed, where the first ground speed is equal to or below a ground speed limit of the agricultural sprayer 10 that is selected based at least in part on a reaction time for controlling an operation of a plurality of nozzle assemblies 68 of the agricultural sprayer 10 in response to sensor feedback from a field condition sensor 74, and spraying parameters (e.g., nozzle height, supply pressure, droplet size, actual application rate, and/or desired application rate).

Further, at (304), the method 300 may include receiving data from a field condition sensor indicative of one or more field conditions within the field as the agricultural sprayer moves across the field. For instance, as discussed above, the controller 202 may receive field condition data from the field condition sensor(s) 74 indicative of one or more field conditions (e.g., weeds W1) within the field 100 as the agricultural sprayer 10 moves across the field 100.

At (306), the method 300 further includes controlling an operation of a plurality of nozzle assemblies of the agricultural sprayer to perform a spraying operation based at least in part on the data received from the field condition sensor. For example, as discussed above, the controller 202 may control the operation of the plurality of nozzle assemblies 68 to perform a spraying operation as the agricultural sprayer 10 moves across the field 100 based at least in part on the data received from the field condition sensor(s) 74 (e.g., to selectively spray weeds W1).

Furthermore, at (308), the method 300 includes monitoring an operating parameter indicative of a travel speed of each of the plurality of nozzle assemblies. For example, as indicated above, the controller 202 may monitor an operating parameter (e.g., travel speed of the boom sections) indicative of a travel speed of each of the plurality of nozzle assemblies 68.

Moreover, at (310), the method 300 includes determining that the travel speed of at least one nozzle assembly of the plurality of nozzle assemblies exceeds or is likely to exceed the ground speed limit based at least in part on the monitored operating parameter. For instance, as indicated above, the controller 202 may be configured to determine that the travel speed of at least one nozzle assembly of the plurality of nozzle assemblies 68 exceeds or is likely to exceed the ground speed limit based at least in part on data received from the associated sensors 78.

Additionally, at (312), the method 300 includes automatically adjusting an operation of the agricultural sprayer in response to the determination that the travel speed of the at least one nozzle assembly exceeds or is likely to exceed the ground speed limit. For example, as discussed above, the controller 202 may be configured to automatically adjust an operation of the at least one nozzle assembly 68 to switch to a continuous spray mode and/or adjust an operation of the speed system 150 of the sprayer 10 to reduce the speed of the sprayer 10.

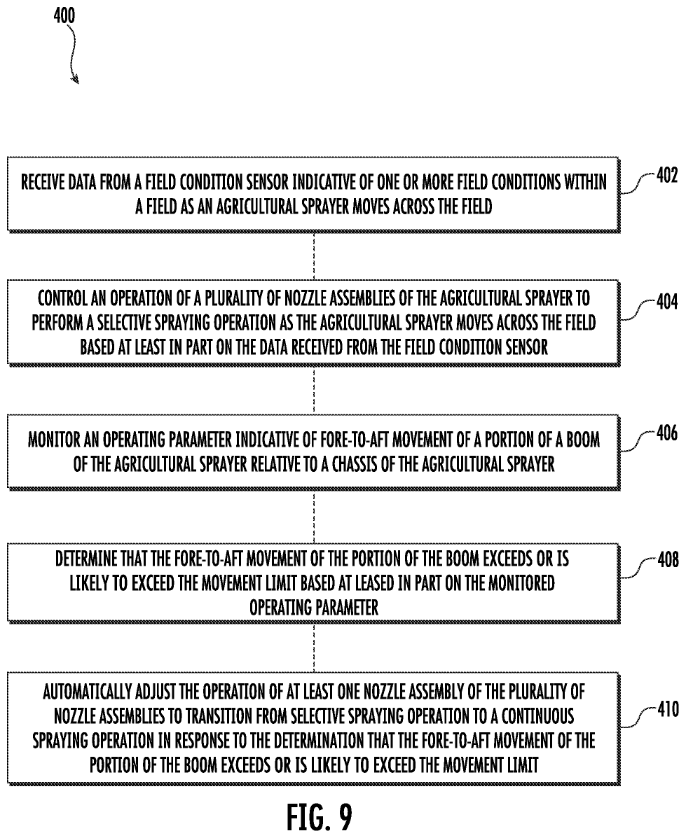

Referring now to FIG. 9, a flow diagram of another embodiment of a method 400 for performing spraying operations with an agricultural sprayer is illustrated in accordance with aspects of the present subject matter. In general, the method 400 will be described herein with reference to the sprayer 10 described above with reference to FIGS. 1-2, the example operational adjustments shown in FIGS. 6A-6B, and the system 200 described above with reference to FIG. 7. However, it should be appreciated that the disclosed method 400 may be implemented with systems having any other suitable system configuration and/or in connection with any other suitable work routes. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 9, at (402), the method 400 may include receiving data from a field condition sensor indicative of one or more field conditions within a field as an agricultural sprayer moves across the field. For instance, as discussed above, the controller 202 may receive field condition data from the field condition sensor(s) 74 indicative of one or more field conditions (e.g., weeds W1) within the field 100 as the agricultural sprayer 10 moves across the field 100.

At (404), the method 400 further includes controlling an operation of a plurality of nozzle assemblies of the agricultural sprayer to perform a selective spraying operation based at least in part on the data received from the field condition sensor. For example, as discussed above, the controller 202 may control the operation of the plurality of nozzle assemblies 68 to perform a selective spraying operation as the agricultural sprayer 10 moves across the field 100 based at least in part on the data received from the field condition sensor(s) 74 (e.g., to selectively spray weeds W1).

Furthermore, at (406), the method 400 includes monitoring an operating parameter indicative of fore-to-aft movement of a portion of a boom of the agricultural sprayer relative to a chassis of the agricultural sprayer. For example, as indicated above, the controller 202 may monitor an operating parameter (e.g., angular position and/or acceleration of the boom sections) indicative of fore-to-aft movement of one or more of the boom sections relative to the chassis 12.

Moreover, at (408), the method 400 includes determining that the fore-to-aft movement of the portion of the boom exceeds or is likely to exceed the movement limit based at least in part on the monitored operating parameter. For instance, as indicated above, the controller 202 may be configured to determine that the fore-to-aft movement of a boom section oscillates to angular positions outside of an angular range and/or oscillates at an acceleration greater than an acceleration limit based at least in part on data received from the associated sensors 80, 82.

Additionally, at (410), the method 400 includes automatically adjusting an operation of at least one nozzle assembly of the plurality of nozzle assemblies to transition from the selective spraying operation to a continuous spraying operation in response to the determination that the fore-to-aft movement of the portion of the boom exceeds or is likely to exceed the movement limit. For example, as discussed above, the controller 202 may be configured to automatically adjust an operation of the nozzle assemblies 68 associated with the boom section(s) that have fore-to-aft movement exceeding the movement limit to switch or transition from the selective spraying mode to a continuous spraying mode.

It is to be understood that the steps of the method 300, 400 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, 400, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300, 400 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for performing spraying operations, the method comprising:
controlling, with one or more computing devices, a speed system of an agricultural sprayer to move the agricultural sprayer across a field at a first ground speed, the first ground speed being equal to or below a ground speed limit of the agricultural sprayer, the ground speed limit being selected based at least in part on a reaction time for controlling an operation of a plurality of nozzle assemblies of the agricultural sprayer in response to sensor feedback from a field condition sensor provided in association with a boom of the agricultural sprayer;
receiving, with the one or more computing devices, data from the field condition sensor indicative of one or more field conditions within the field as the agricultural sprayer moves across the field;
controlling, with the one or more computing devices, the operation of the plurality of nozzle assemblies to perform a spraying operation as the agricultural sprayer moves across the field based at least in part on the data received from the field condition sensor;
monitoring, with the one or more computing devices, an operating parameter indicative of a travel speed of each of the plurality of nozzle assemblies;
determining, with the one or more computing devices, that the travel speed of at least one nozzle assembly of the plurality of nozzle assemblies exceeds or is likely to exceed the ground speed limit based at least in part on the monitored operating parameter; and
automatically adjusting, with the one or more computing devices, an operation of the agricultural sprayer in response to the determination that the travel speed of the at least one nozzle assembly exceeds or is likely to exceed the ground speed limit.

2. The method of claim 1, wherein the monitored operating parameter comprises a first travel speed of a first boom portion of the boom and a second travel speed of a second boom portion of the boom, the first and second boom portions extending from opposite sides of the agricultural sprayer,
wherein determining that the travel speed of the at least one nozzle assembly of the plurality of nozzle assemblies exceeds or is likely to exceed the ground speed limit comprises determining that the first travel speed or the second travel speed exceeds or is likely to exceed the ground speed limit.

3. The method of claim 2, wherein, when the at least one nozzle assembly is supported on the first boom portion, automatically adjusting the operation of the agricultural sprayer comprises controlling the at least one nozzle assembly to continuously spray when the first travel speed exceeds or is likely to exceed the ground speed limit,
wherein, when the at least one nozzle assembly is supported on the second boom portion, automatically adjusting the operation of the agricultural sprayer comprises controlling the at least one nozzle assembly to continuously spray when the second travel speed exceeds or is likely to exceed the ground speed limit.

4. The method of claim 2, wherein automatically adjusting the operation of the agricultural sprayer comprises controlling the speed system to move the agricultural sprayer across the field at a second ground speed when the first travel speed or the second travel speed exceeds or is likely to exceed the ground speed limit, the second ground speed being lower than the first ground speed.

5. The method of claim 1, wherein the travel speed of each of the plurality of nozzle assemblies is determined based at least in part on a position of each of the plurality of nozzle assemblies along the boom.

6. The method of claim 1, wherein the ground speed limit is based at least in part on one or more of a turning radius of the agricultural sprayer, a nozzle height, spray pressure, droplet size, application rate, a look-ahead distance of the field condition sensor, a processing lag for processing the data received from the field condition sensor, and a control lag for adjusting the operation of the plurality of nozzle assemblies.

7. The method of claim 1, wherein the data received from the field condition sensor is indicative of plants within the field that require selective application of an agricultural fluid via execution of the spraying operation,
wherein controlling the operation of the plurality of nozzle assemblies to perform the spraying operation as the agricultural sprayer moves across the field comprises controlling the plurality of nozzle assemblies to selectively apply the agricultural fluid to the identified plants.

8. The method of claim 1, further comprising identifying the locations of weeds within the field based on the data received from the field condition sensor as the agricultural sprayer moves across the field,
wherein controlling the operation of the plurality of nozzle assemblies to perform the spraying operation as the agricultural sprayer moves across the field comprises controlling the plurality of nozzle assemblies to selectively spray the weeds within the field as the agricultural sprayer moves across the field.

9. A system for performing spraying operations, the system comprising:
a boom;
a plurality of nozzle assemblies supported on the boom, each of the plurality of nozzle assemblies being configured to selectively dispense an agricultural product as an agricultural sprayer moves across a field;
a field condition sensor provided in association with the boom, the field condition sensor being configured to generate data indicative of a field condition within the field; and
a controller communicatively coupled to the field condition sensor, the controller comprising a processor and a memory, the memory being configured to store instructions that, when executed by the processor, configure the controller to:
control a speed system of the agricultural sprayer to move the agricultural sprayer across the field at a first ground speed, the first ground speed being equal to or below a ground speed limit for the agricultural sprayer, the ground speed limit being selected based at least in part on a reaction time for controlling an operation of the plurality of nozzle assemblies in response to sensor feedback from the field condition sensor;
receive the data from the field condition sensor as the agricultural sprayer moves across the field;
control the operation of the plurality of nozzle assemblies to perform a spraying operation as the agricultural sprayer moves across the field based at least in part on the data received from the field condition sensor;
monitor an operating parameter indicative of a travel speed of each of the plurality of nozzle assemblies;
determine that the travel speed of at least one nozzle assembly of the plurality of nozzle assemblies exceeds or is likely to exceed the ground speed limit based at least in part on the monitored operating parameter; and
automatically adjust an operation of the agricultural sprayer in response to the determination that the travel speed of the at least one nozzle assembly exceeds or is likely to exceed the ground speed limit.

10. The system of claim 9, wherein the monitored operating parameter comprises a first travel speed of a first boom portion of the boom and a second travel speed of a second boom portion of the boom, the first and second boom portions extending from opposite sides of the agricultural sprayer,
wherein determining that the travel speed of the at least one nozzle assembly of the plurality of nozzle assemblies exceeds or is likely to exceed the ground speed limit comprises determining that the first travel speed or the second travel speed exceeds or is likely to exceed the ground speed limit.

11. The system of claim 10, wherein, when the at least one nozzle assembly is supported on the first boom portion, automatically adjusting the operation of the agricultural sprayer comprises controlling the at least one nozzle assembly to continuously spray when the first travel speed exceeds or is likely to exceed the ground speed limit,
wherein, when the at least one nozzle assembly is supported on the second boom portion, automatically adjusting the operation of the agricultural sprayer comprises controlling the at least one nozzle assembly to continuously spray when the second travel speed exceeds or is likely to exceed the ground speed limit.

12. The system of claim 10, wherein automatically adjusting the operation of the agricultural sprayer comprises controlling the speed system to move the agricultural sprayer across the field at a second ground speed when the first travel speed or the second travel speed exceeds or is likely to exceed the ground speed limit, the second ground speed being lower than the first ground speed.

13. The system of claim 9, wherein the travel speed of each of the plurality of nozzle assemblies is determined at least in part on a position of each of the plurality of nozzle assemblies along the boom.

14. The system of claim 9, wherein the ground speed limit is based at least in part on one or more of a turning radius of the agricultural sprayer, a nozzle height, spray pressure, droplet size, application rate, a look-ahead distance of the field condition sensor, a processing lag for processing the data received from the field condition sensor, and a control lag for adjusting the operation of the plurality of nozzle assemblies.

15. The system of claim 9, wherein the data received from the field condition sensor is indicative of plants within the field that require selective application of the agricultural product via execution of the spraying operation,
wherein controlling the operation of the plurality of nozzle assemblies to perform the spraying operation as the agricultural sprayer moves across the field comprises controlling the plurality of nozzle assemblies to selectively apply the agricultural product to the identified plants.

16. The system of claim 9, wherein the controller is further configured to identify the locations of weeds within the field based on the data received from the field condition sensor as the agricultural sprayer moves across the field,
wherein controlling the operation of the plurality of nozzle assemblies to perform the spraying operation as the agricultural sprayer moves across the field comprises controlling the plurality of nozzle assemblies to selectively spray the weeds within the field as the agricultural sprayer moves across the field.

17. A method for performing spraying operations, the method comprising:
receiving, with the one or more computing devices, data from a field condition sensor indicative of one or more field conditions within a field as an agricultural sprayer moves across the field, the field condition sensor being provided in association with a boom of the agricultural sprayer;
controlling, with the one or more computing devices, an operation of a plurality of nozzle assemblies of the agricultural sprayer to perform a selective spraying operation as the agricultural sprayer moves across the field based at least in part on the data received from the field condition sensor;
monitoring, with the one or more computing devices, an operating parameter indicative of fore-to-aft movement of a portion of the boom relative to a chassis of the agricultural sprayer;
determining, with the one or more computing devices, that the fore-to-aft movement of the portion of the boom exceeds or is likely to exceed a movement limit based at least in part on the monitored operating parameter; and
automatically adjusting, with the one or more computing devices, the operation of at least one nozzle assembly of the plurality of nozzle assemblies to transition from the selective spraying operation to a continuous spraying operation in response to the determination that the fore-to-aft movement of the portion of the boom exceeds or is likely to exceed the movement limit.

18. The method of claim 17, wherein the portion of the boom pivots about an axis during the fore-to-aft movement, the method further comprising controlling, with the one or more computing devices, a fold actuator to reduce the pivoting of the portion of the boom about the axis in response to the determination that the fore-to-aft movement exceeds or is likely to exceed the movement limit, the fold actuator being configured to pivot the portion of the boom about the axis between a working position and a transport position.

19. The method of claim 17, wherein the monitored operating parameter comprises an acceleration of the portion of the boom, the movement limit comprising an acceleration limit for the portion of the boom.

20. The method of claim 17, wherein the monitored operating parameter comprises an angular position of the portion of the boom, the movement limit comprising an angular range between a maximum forward angular position limit and a maximum rearward angular position limit, the angular position of the portion of the boom exceeding the movement limit when the angular position of the portion of the boom exceeds or is likely to exceed the maximum forward angular position limit or the maximum rearward position limit.
